(19) United States
(12) Patent Application Publication
(10) Pub. No.: US 2010/0059058 A1
(43) Pub. Date: Mar. 11, 2010

(54) CPAP mask

(76) Inventor: Tzong-Fuh Kuo, Hsin Juang City (TW)

Correspondence Address: PRO-TECHTOR INTERNATIONAL SERVICES, 20775 NORADA CT., SARATOGA, CA, 95070, US

(21) Appl. No.: 12/209,191

(22) Filed: Sep. 11, 2008

(51) Int. Cl. A62B 18/02

(52) U.S. Cl. 128/205.25

(57) ABSTRACT

A CPAP mask, within which is disposed a membrane that effectively separates air and carbon dioxide within a face mask into two air chambers, and a one-way air escape valve plate is fitted to an air vent at one end of the face mask. Accordingly, when air is input into the CPAP mask through a CPAP (Continuous Positive Airway Pressure) ventilator, one portion of the air expels the CO₂ exhaled by the patient through the one-way air escape valve plate, while the other portion of the air is inhaled by the patient, thereby enabling the patient to inhale fresh air with each respiration.

### BACKGROUND OF THE INVENTION

(a) Field of the Invention

The present invention relates to a CPAP mask, and more particularly to a mask which is able to separate air and carbon dioxide to enable a patient to continuously inhale fresh air when sleeping.

(b) Description of the Prior Art

Continuous Positive Airway Pressure (CPAP) is used when patients with respiratory disorder are sleeping, and delivers continuous positive airway pressure into the air passage of the patient to prevent temporary breathing stoppage of the patient, causing oxygen deficiency and creating an emergency situation for the patient. However, the carbon dioxide exhaled by patients within CPAP masks of the prior art is excessive and cannot be effectively eliminated, and often causes the patient to awake suddenly or seriously affects sleep quality because of the insufficient oxygen content for respiration.

### SUMMARY OF THE INVENTION

The primary object of the present invention is to provide a CPAP mask, within which is disposed a membrane to effectively separate air and carbon dioxide. In addition, a one-way air escape valve plate is disposed in a carbon dioxide air chamber of a face mask. Accordingly, when fresh air is input into the CPAP mask through a CPAP (Continuous Positive Airway Pressure) ventilator, one portion of the air expels the CO₂ exhaled by the patient through the one-way air escape valve plate, while the other portion of the air is inhaled by the patient, thereby enabling the patient to continuously inhale fresh air within the CPAP mask.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows a perspective view of the present invention.

FIG. 2 shows an exploded perspective view of the present invention.

FIG. 3 shows a rear sectional view of the present invention.

### DETAILED DESCRIPTION OF THE PREFERRED EMBODIMENTS

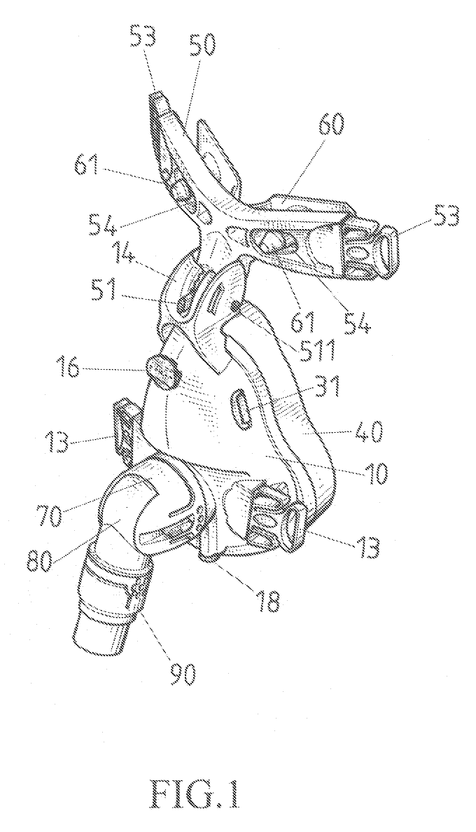

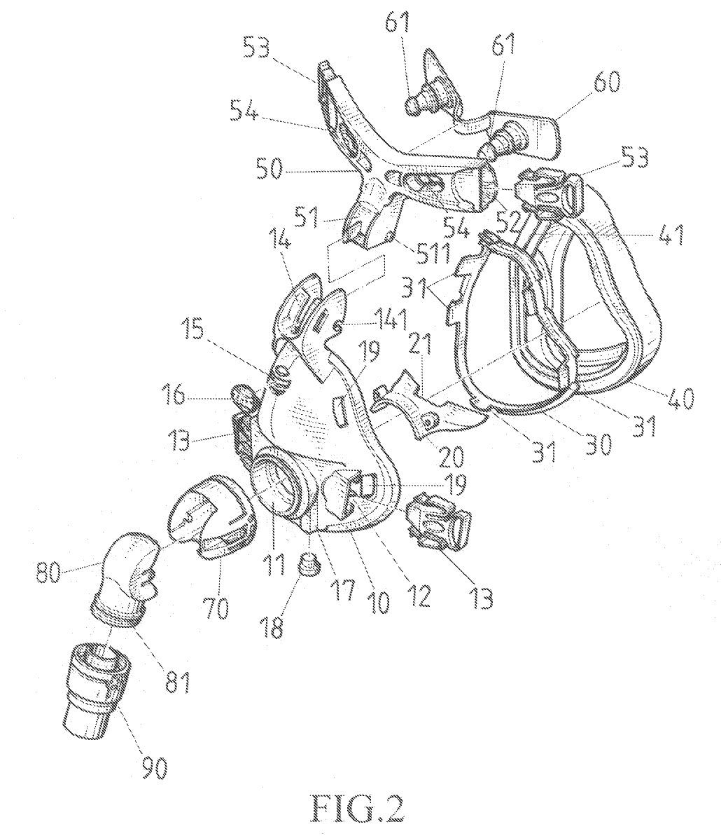

Referring to FIGS. 1 to 3, the present invention comprises components including a face mask 10, a membrane 20, a fixing ring 30, a silica gel lining 40, a forehead fixing mount 50, a fixed lining 60, a rotating head 70, a connection tube 80 and a pipe attachment 90.

Wherein, a front side of a bottom portion of the face mask 10 is provided with a through hole 11, two sides of the through hole 11 are respectively provided with a fastening mount 12, and belt fasteners 13 are respectively inserted within the fastening mount 12. Moreover, straps (not shown in the drawings) can be fastened to the belt fasteners 13. The top end of the face mask 10 is provided with an upper cover 14, and an air vent 15 is provided at a lower end of the upper cover 14. A valve plate 16 is embedded into the air vent 15, and air ports 17 at a bottom portion of the through hole 11 are respectively embedded with plugs 18.

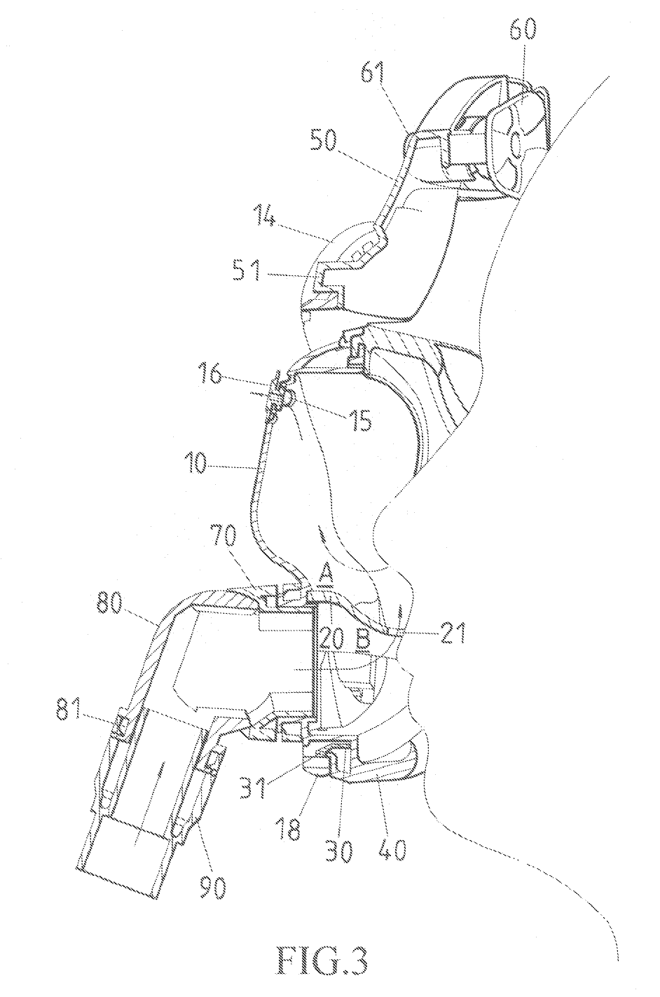

The soft membrane 20 is connected to an inner side of the through hole 11 of the face mask 10, thereby internally separating the face mask into an upper and a lower air chamber A, B (as shown in FIG. 3). One end of the membrane 20 is provided with a vent outlet 21.

Clasps 31 on a front edge of the fixing ring 30 are used to respectively fixedly clasp into clamping holes 19 of the face mask 10.

Lining holes 41 in a front side of the silica gel lining 40 are used to enable fixing an end of the fixing ring 30.

A bottom portion of the forehead fixing mount 50 is fitted with an angle adjuster 51, and clamping pieces 511 of two sides of the angle adjuster 51 are fixedly clamped into clamping holes 141 of the upper cover 14 of the face mask 10. Belt fasteners 53 are able to be respectively inserted into fastening mounts 52 of two sides of the forehead fixing mount 50, and the belt fasteners 53 can be fastened to straps (not shown in the drawings). Two sides of the center of the forehead fixing mount 50 are respectively provided with a position fixing slot 54, and the position fixing slots 54 are provided with different positioned position fixing holes.

A front edge of the fixed lining 60 is provided with two fastening clasps 61, and the fastening clasps 61 are respectively fixedly clasped into the position fixing slots 54 of the forehead fixing mount 50; fixedly clasping of the fastening clasps 61 into the different positioned position fixing holes within the position fixing slots 54 is determined according to the width of the forehead a patient.

The rotating head 70 is mounted onto the orifice of the through hole 11 of the face mask 10.

One end of the connection tube 80 is connected to the rotating head 70, and the other end is provided with a thread 81.

One end of the pipe attachment 90 enables the thread 81 of the connection tube 80 to be fixedly screwed thereto, while the other end is connected to a CPAP (Continuous Positive Airway Pressure) ventilator (not shown in the drawings).

The membrane 20 of the present invention is located between the nose and mouth of a patient to separate carbon dioxide and air into the two air chambers A, B, and the one-way air escape valve plate 16 is located in the upper air chamber A. When a patient with respiratory disorder is wearing the CPAP mask when sleeping, the fresh airflow input by the positive airway pressure of the CPAP ventilator passes through the pipe attachment 90, the rotating head 70 and enters the face mask 10, whereupon one portion of the fresh air expels the CO₂ exhaled by the patient through the one-way air escape valve plate 16 of the CO₂ air chamber A, while the other portion of the air is inhaled by the patient, thereby enabling the patient to inhale fresh air with each respiration.

As is apparent from the foregoing, the CPAP mask of the present invention is able to separate air and carbon dioxide, thereby enabling a patient to continuously inhale fresh air when sleeping while preventing inhaling excessive amounts of CO₂, which would otherwise affect the quality of sleep or cause oxygen deficiency.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A CPAP mask, comprising:
a face mask, a top end of the face mask is provided with an upper cover, a lower portion of the upper cover is provided with an air vent, and a one-way valve plate is embedded in the air vent;
a membrane, the membrane is connected to an inner side of a through hole of the face mask, thereby separating the face mask into two air chambers, and one end of the membrane is provided with a vent outlet;
a forehead fixing mount installed to an upper portion of the face mask, two sides of a center of the forehead fixing mount are respectively provided with a position fixing slot, and the position fixing slots are Internally provided with different positioned position fixing holes;
a fixed lining, a front edge of the fixed lining is provided with two fastening clasps, and the fastening clasps are respectively fixedly clasped into the position fixing slots of the forehead fixing mount, fixedly clasping of the fastening clasps into the different positioned position fixing holes within the position fixing slots is determined according to the width of the forehead a patient.

2. The CPAP mask in accordance with claim 1, wherein a front side of a bottom portion of the face mask is provided with the through hole, and a rotating head is connected within the through hole; the rotating head is connected to a pipe attachment and, the pipe attachment is connected to a CPAP (Continuous Positive Airway Pressure) ventilator.

3. The CPAP mask in accordance with claim 1, wherein the face mask is provided with clamping holes to enable clasps of a fixing ring to fixedly clasp therein, and a silica gel lining is fixed to the fixing ring.

4. The CPAP mask in accordance with claim 1, wherein clamping holes of the upper cover of the face mask enable clamping pieces of an angle adjuster at a bottom portion of the forehead fixing mount to fixedly clamp therein.

5. The CPAP mask in accordance with claim 1, wherein two sides of the through hole are respectively provided with a fastening mount to enable belt fasteners to be inserted therein.

6. The CPAP mask in accordance with claim 1, wherein two sides of the forehead fixing mount are respectively provided with a fastening mount to enable belt fasteners to be inserted therein.
